(19) United States
(12) Patent Application Publication
(10) Pub. No.: US 2008/0160360 A1
(43) Pub. Date: Jul. 3, 2008

(54) Fuel cell purge cycle apparatus and method

(76) Inventors: Keith A. Fennimore, Columbus, NJ (US); Kevin W. McNamara, Red Bank, NJ (US); Richard M. Mohring, East Brunswick, NJ (US)

Correspondence Address: DICKSTEIN SHAPIRO LLP, 1825 EYE STREET NW, Washington, DC, 20006-5403, US

(21) Appl. No.: 11/785,037

(22) Filed: Apr. 13, 2007

Related U.S. Application Data
(60) Provisional application No. 60/791,416, filed on Apr. 13, 2006.
(60) Provisional application No. 60/802,532, filed on May 23, 2006.

(51) Int. Cl. H01M 8/04; H01M 8/06

(52) U.S. Cl. 429/17; 429/12; 429/25; 429/19; 429/34; 429/20

(57) ABSTRACT

Systems and methods are provided in which a fuel cell purge cycle recaptures fluid material such as water and hydrogen from an electrode of a fuel cell and can recycle the hydrogen to the anode, leading to improved fuel cell efficiency with minimal parasitic load. Pressure fluctuations of a hydrogen generation system may be integrated with the fuel cell purge cycle to recycle hydrogen to the fuel cell and water to the hydrogen generation system.

### CROSS-REFERENCE TO RELATED APPLICATIONS

This application claims the benefit of U.S. Provisional Application Ser. No. 60/791,416, filed Apr. 13, 2006, and U.S. Provisional Application Ser. No. 60/802,532, filed May 23, 2006, the entire disclosures of which are incorporated by reference herein.

### STATEMENT REGARDING FEDERALLY SPONSORED RESEARCH OR DEVELOPMENT

This invention was made with Government support under Technology Investment Agreement FA8650-04-3-2411 awarded by the United States Air Force. The Government has certain rights in this invention.

### BACKGROUND OF THE INVENTION

Fuel cell power systems are emerging as alternatives for batteries in a variety of portable power applications as they can couple high energy density with a convenient ability to be refueled. A hydrogen consuming fuel cell produces electricity through the reactions shown in the Equations 1a, 1b, and 1c.

Anode: 2H₂→4H⁺+4e⁻ Eqn. 1a

Cathode: O₂+4H⁺+4e⁻→2H₂O Eqn. 1b

Net Reaction: 2H₂+O₂→2H₂O Eqn. 1c

During operation, fluid material such as water and gases tend to accumulate in one or both of the electrode (e.g., the cathode and anode) compartments. For optimum efficiency, this water may be periodically purged from the electrode compartment along with any accumulated gases by fuel cell purge cycles that either shunt hydrogen through a valve to the atmosphere or mechanically compress the hydrogen and re-introduce it to the anode of the fuel cell. However, in both scenarios, overall system efficiency is sacrificed.

### BRIEF SUMMARY OF THE INVENTION

In one embodiment of the present invention, a fuel cell purge cycle captures fluid material such as water and hydrogen from the cathode of a fuel cell and recycles the hydrogen to the anode, leading to improved fuel cell efficiency with minimal parasitic load.

In another embodiment of the invention, the pressure fluctuations of a boron hydride hydrogen generation system are integrated with a fuel cell purge cycle to capture fluid material such as water and hydrogen from the cathode of a fuel cell and recycle the hydrogen to the anode and store the water in a storage tank.

In another embodiment of the invention, the pressure fluctuations of a boron hydride hydrogen generation system are integrated with a fuel cell purge cycle to capture fluid material such as water and hydrogen from the cathode of a fuel cell and recycle the hydrogen to the anode and deliver the water to dilute a fuel concentrate.

In another embodiment of the present invention, a fuel cell purge cycle captures fluid material such as water and hydrogen from the anode of a fuel cell and recycles the hydrogen to the anode, leading to improved fuel cell efficiency with minimal parasitic load.

In another embodiment of the invention, the pressure fluctuations of a boron hydride hydrogen generation system are integrated with a fuel cell purge cycle to capture fluid material such as water and hydrogen from the anode of a fuel cell and recycle the hydrogen to the anode and store the water in a storage tank.

In another embodiment of the invention, the pressure fluctuations of a boron hydride hydrogen generation system are integrated with a fuel cell purge cycle to capture fluid material such as water and hydrogen from the anode of a fuel cell and recycle the hydrogen to the anode and deliver the water to dilute a fuel concentrate.

A complete understanding of the present invention may be obtained by reference to the accompanying drawings when considered in conjunction with the following detailed description, in which:

### BRIEF DESCRIPTION OF THE DRAWINGS

FIG. 1 is a schematic illustration of a fuel cell power system useful for practicing an embodiment of the present invention;

FIG. 2 is a schematic illustration of a fuel cell power system useful for practicing another embodiment of the present invention;

FIG. 3 is a graphical representation of pressure fluctuations within a fuel cell power system in accordance with an embodiment of the present invention;

FIG. 4 is a graphical representation of pressure fluctuations within a fuel cell power system in accordance with an embodiment of the present invention;

FIG. 5 is a graphical representation of pressure fluctuations within a fuel cell power system in accordance with an embodiment of the present invention;

FIG. 6 is a schematic illustration of a fuel cell power system integrated with a borohydride hydrogen generating system useful for practicing an embodiment of the present invention; and

FIG. 7 is a schematic illustration of a fuel cell power system integrated with a borohydride hydrogen generating system useful for practicing another embodiment of the present invention.

### DETAILED DESCRIPTION OF THE INVENTION

The term “fuel cell” as used herein refers to any type of fuel cell that consumes hydrogen gas such as a proton exchange membrane fuel cell (PEM), a solid oxide fuel cell (SOFC), or an alkaline fuel cell (AFC), among others. The fuel cell may be equipped with a hydrogen inlet and an oxygen inlet to intake the gaseous components necessary for electricity generation, for example, as per equation (1c) as is typical for PEM fuel cells.

The term “boron hydrides” as used herein refers to and includes boranes, polyhedral boranes, and anions of borohydrides or polyhedral boranes, such as those disclosed in co-pending U.S. patent application Ser. No. 10/741,199, entitled “Fuel Blends for Hydrogen Generators,” the disclosure of which is hereby incorporated herein by reference in its entirety. Suitable boron hydrides include, without intended limitation, neutral borane compounds such as decaborane(14) (B₁₀H₁₄); ammonia borane compounds of formula NHₓBH_{y} and NHₓRBH_{y}, wherein x and y independently=1 to 4 and do not have to be the same, and R is a methyl or ethyl group; borazane (NH₃BH₃); borohydride salts M(BH₄)ₙ, triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, where M is a cation selected from the group consisting of alkali metal cations, alkaline earth metal cations, aluminum cation, zinc cation, and ammonium cation, and n is equal to the charge of the cation. M is preferably sodium, potassium, lithium, or calcium. These metal hydrides may be utilized in mixtures, but are preferably utilized individually. The boron hydride fuels may be prepared as aqueous mixtures and may contain a stabilizer component, such as a metal hydroxide having the general formula M(OH)ₙ, wherein M is a cation selected from the group consisting of alkali metal cations such as sodium, potassium or lithium, alkaline earth metal cations such as calcium, aluminum cation, and ammonium cation, and n is equal to the charge of the cation.

The fuel cell purge cycle according to preferred embodiments of the present invention captures fluid material such as water and hydrogen from at least one electrode compartment (e.g., the cathode or the anode) of a fuel cell and recycles the hydrogen to the anode, leading to improved hydrogen utilization and thus higher overall fuel cell efficiency. The recovered hydrogen can be redelivered to the anode together with hydrogen provided directly from a hydrogen source. This may be accomplished with minimal or no electronic and mechanical components that would result in a parasitic load, and without requiring additional compression. Reclamation allows a greater percentage of the hydrogen fuel to be converted to power by the fuel cell, which increases the fuel cell power system energy density.

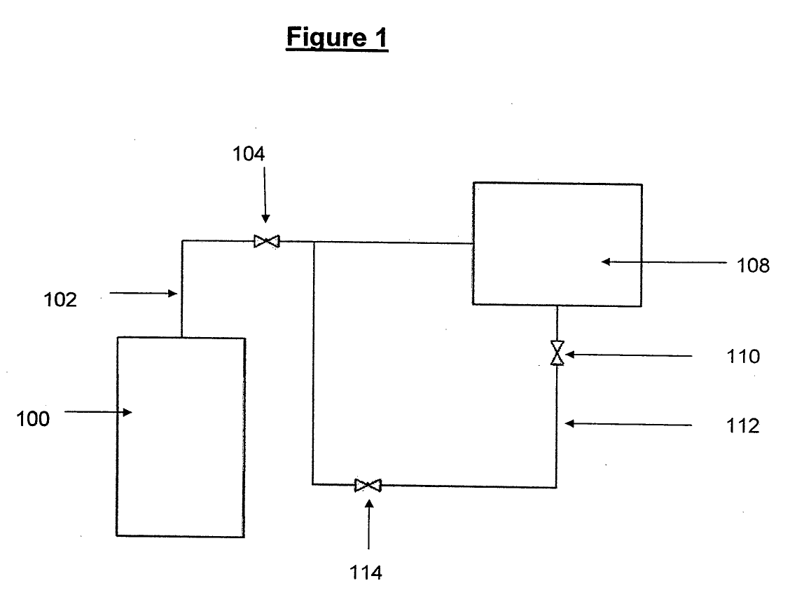

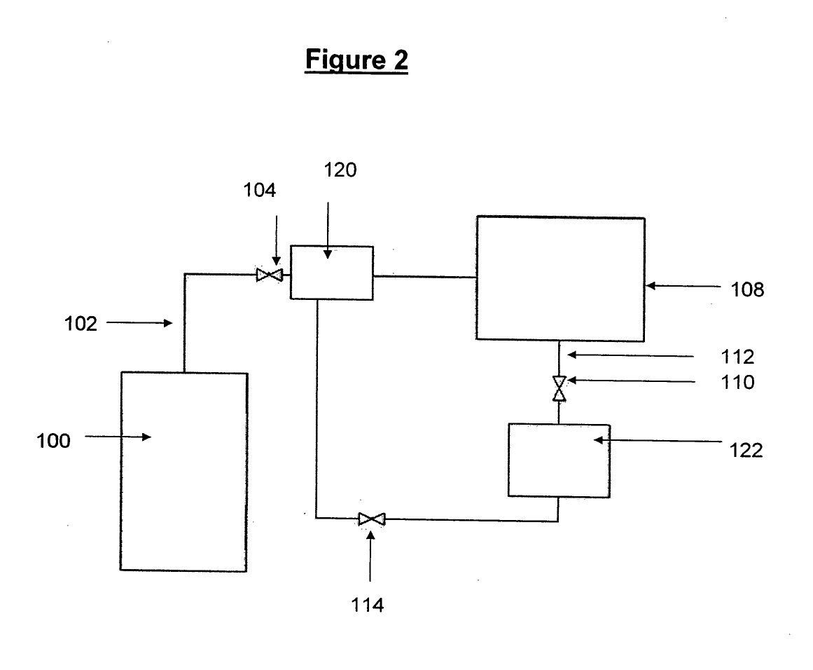

A general embodiment of a fuel cell power system according to the present invention is provided in FIG. 1 and comprises a hydrogen fuel source 100, a fuel cell 108, valves 104, 110 and 114; a conduit line 102 to deliver hydrogen from the hydrogen fuel source to the fuel cell, and a second conduit line 112 connecting the electrode chamber of the fuel cell 108 to the hydrogen supply line 102. The conduit line 112 may be connected to either the anode or the cathode compartment of the fuel cell. In such a design, sufficient ballast volume is present within the system to accommodate any liquid and gaseous material removed from the fuel cell. As shown in FIG. 2, the ballast volume necessary within the fuel cell power system is represented as storage regions 120 and 122 which may store gas or liquids. The regions 120 and 122 may be discrete tanks within the system or may simply be areas of available volume within the conduit lines 102 and 112.

The preferred systems and methods of the present invention purge water and accumulated gases from a fuel cell by creating a pressure difference between the fuel cell and the storage region downstream. A valve between the fuel cell and the storage region isolates the two zones and, when open, allows the higher pressure in the fuel cell to expel gaseous and liquid materials into the storage region.

The hydrogen source 100 may be a hydrogen storage tank, such as a gaseous hydrogen tank or a metal hydride, or a hydrogen generation system that produces hydrogen by reformation of hydrocarbons or chemical hydrides, wherein hydrocarbons undergo reaction with water to generate hydrogen gas and carbon oxides and chemical hydrides react with water to produce hydrogen gas and a metal salt. Hydrocarbon fuels include methanol, ethanol, butane, gasoline, and diesel; methanol is preferred for such systems in accordance with the present invention. Chemical hydride fuels include the alkali and alkaline earth metal hydrides and boron hydrides.

Valves 110 and 114 may be, for example, check valves or similar valves that permit flow in only one direction, mechanical valves, or electromechanical valves such as solenoid valves; the same type of valve does not have to be chosen for both. Valve 104 may be, for example, a solenoid valve or a gas pressure regulator. Check valves typically do not create any parasitic load on the system while other valves may.

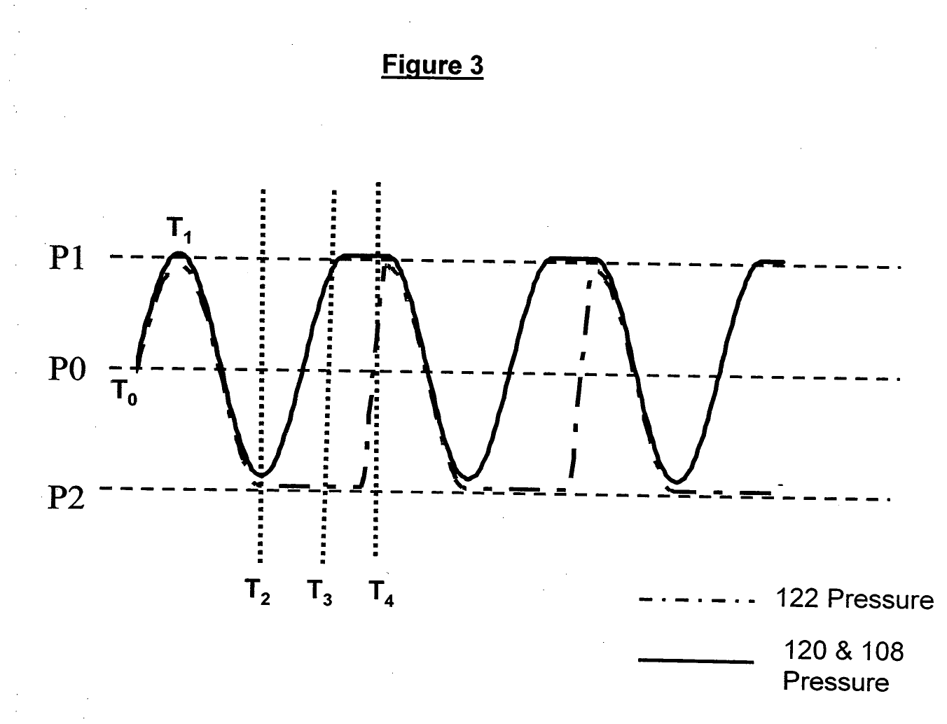

In one embodiment of the method of creating a pressure difference to purge a fuel cell according to the present invention, the system of FIG. 1 and FIG. 2 may be considered to be divided into two portions—a first isolable region which comprises the fuel cell, a storage region 120, and conduit 102 and is bounded by valves 104, 110, and 114, and a second isolable region which comprises the storage region 122 and conduit 112 and is bounded by valves 110 and 114. Referring to FIG. 3 and Table 1, the pressure of these two isolable regions is cycled between a higher pressure P₁ and a lower pressure P₂, creating a pressure difference between the isolable regions during operation.

TABLE 1

| | | Pressure | | |
|---|---|---|---|---|
| Step | Time | 120 | 108 | 122 |
| Start-up | T₀ | P₀ | P₀ | P₀ |
| Pressurization | T₀→T₁ | P₁ | P₁ | P₁ |
| Fuel Cell | T₁→T₂ | P₂ | P₂ | P₂ |
| Operation | | | | |
| Re-pressurization | T₂→T₃ | P₁ | P₁ | P₂ |
| Fuel Cell Purge | T₃→T₄ | P₁ | P₁ | P₁ |

Initially at T₀, all components in the system shown in FIG. 1 may reside at an initial pressure, P₀ (Start-Up Step). In the Pressurization Step, the valve 104 is opened to provide hydrogen from the hydrogen supply 100 and the system is pressurized to the operating pressure P₁ of the fuel cell 108 as shown in Table 1. For closed cycle operation, the valve 104 can be closed to isolate the hydrogen supply 100 from the remainder of the system so that only the ballast hydrogen stored in region 120 is supplied to the fuel cell.

If the system is operating in a closed cycle, as the fuel cell converts hydrogen to electricity in the Fuel Cell Operation Step, hydrogen is consumed and the pressure in the communicating regions falls to a lower pressure, P₂. Valves 110 and 104 are closed to isolate the region 122 from pressure swings in the fuel cell power system and maintain this area at P₂. Any and all references herein to “opening” and “closing” valves are not limited to actively controlled valves such as mechanical or electromechanical valves. For example, an electromechanical valve such as a solenoid valve may be activated by a signal controlling the electrical current through a solenoid. However, a check valve generally has a mechanism, such as a spring or hinge, that holds the valve closed until a preset pressure is achieved to overcome the resistance and open the valve. Thus, a mechanical or electromechanical valve may be operated in response to a signal such as, but not limited to, time or pressure, and a check valve may operate in response to pressure conditions within the system.

In the Re-Pressurization Step, valve 104 can be opened to provide hydrogen from the hydrogen supply 100 and re-pressurize those system components in communication to a pressure higher than P₂, such as P₁ or P₀; the isolated region 122 remains at the lower pressure P₂.

In the Fuel Cell Purge Step, when the communicating system (e.g., the fuel cell 108, the region 120, and the associated connecting conduits) reach the higher pressure, for example, P₁, valve 110 is opened and residual hydrogen, product water and any impurities from the fuel cell electrode in communication with conduit 112 and region 122 are flushed into the region 122 under the influence of the pressure drop between the fuel cell 108 and the region 122. With valves 104 and 110 open, all communicating regions can equilibrate to the same pressure, P₁, and the cycle of fuel cell operation and fuel cell purge can repeat.

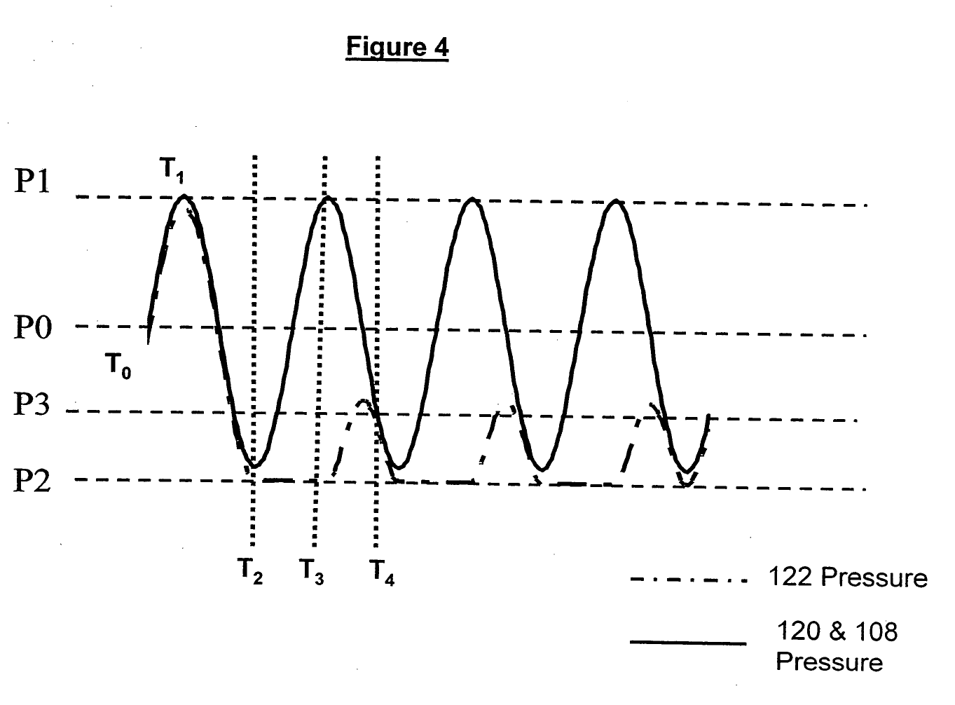

It is not necessary that the communicating regions equilibrate to the same pressure in this Fuel Cell Purge Step. FIG. 4 demonstrates the method wherein region 122 is maintained at a different pressure than the remainder of the system. When the communicating system (e.g., the fuel cell 108, the region 120, and the associated connecting conduits) reaches the higher pressure, for example, P₁, valve 104 is closed and valve 110 is opened and residual hydrogen, product water and any impurities from a fuel cell electrode such as the cathode or anode are flushed into the region 122 under the influence of the pressure drop between the fuel cell 108 and the region 122. The pressures of the two regions equilibrate at a pressure P₃.

If desired, valve 110 may be left open allowing the pressure of both regions to decrease together to pressure P₂ as hydrogen is consumed by the fuel cell. The cycle of pressurization, fuel cell operation, and fuel cell purge can repeat by operating valves 104, 110 and 114.

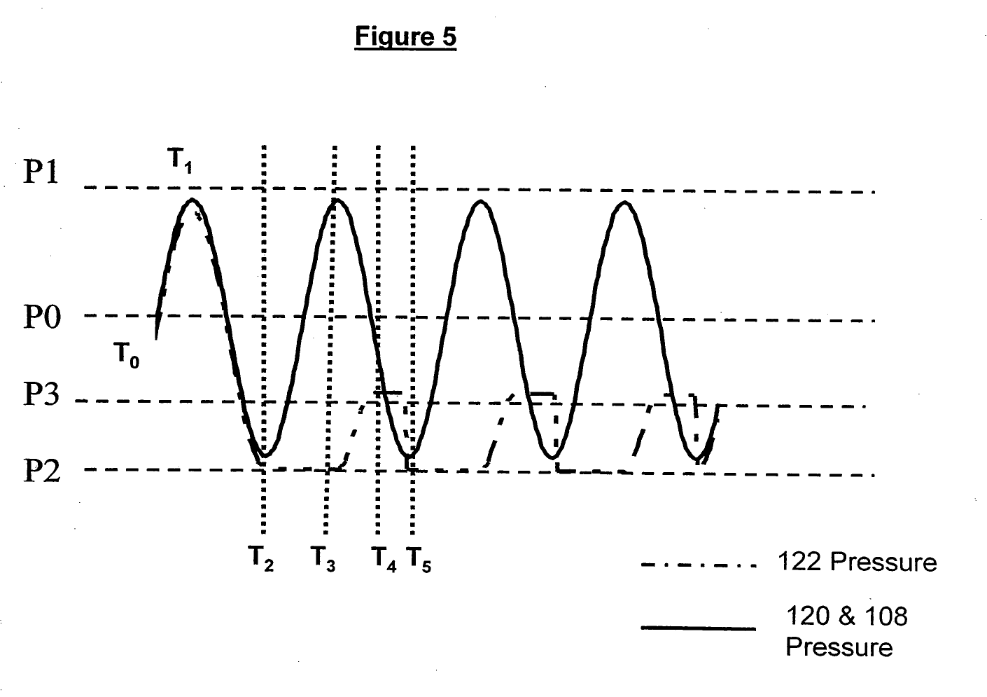

Referring now to FIG. 5 and Table 2, an optional Reclamation Step may be added by closing valve 110 when the pressure of region 122 reaches pressure P₃, while allowing the remainder of the system to fall to pressure P₂ as hydrogen is consumed by the fuel cell.

TABLE 2

| | | Pressure at End | | |
|---|---|---|---|---|
| | | of Time Segment | | |
| Step | Time | 120 | 108 | 122 |
| Start-up | T₀ | P₀ | P₀ | P₀ |
| Pressurization | T₀→T₁ | P₁ | P₁ | P₁ |
| Fuel Cell | T₁→T₂ | P₂ | P₂ | P₂ |
| Operation | | | | |
| Re-pressurization | T₂→T₃ | P₁ | P₁ | P₂ |
| Fuel Cell | T₃→T₄ | P₃ | P₃ | P₃ |
| Consumption and | | | | |
| Fuel Cell Purge | | | | |
| Reclamation | T₄→T₅ | P₂ | P₂ | P₂ |

In the Reclamation Step, any accumulated materials present in the region 122 can be transferred to the ballast region 120 by opening the valve 114. The higher pressure in region 122 (e.g., P₃>P₂) forces any accumulated water and hydrogen into region 120; the communicating regions all equilibrate to the same pressure, P₂. Following the purge from region 122 to region 120, the valve 114 may be closed to again isolate region 122 from 120, and the cycle of pressurization, fuel cell operation, and fuel cell purge can repeat by operating valves 104, 110 and 114.

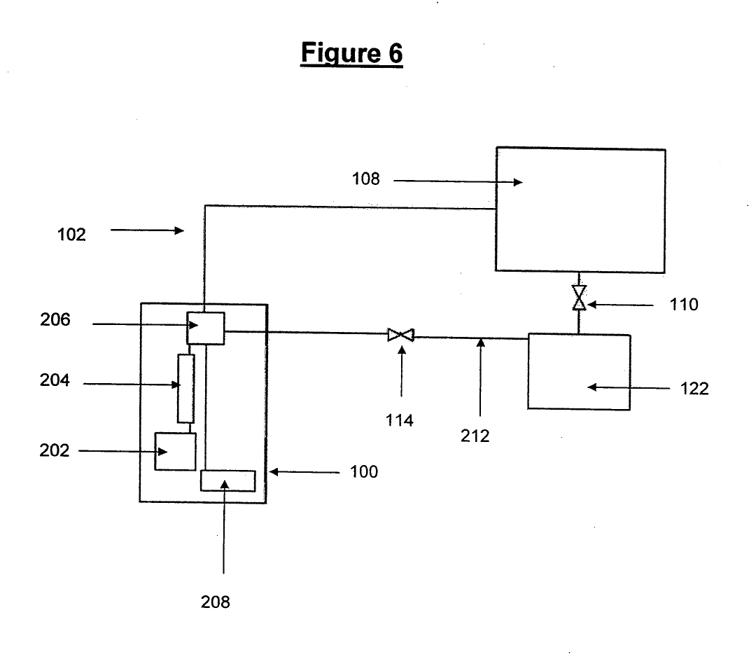

Referring now to FIG. 6, a preferred embodiment of a fuel cell power system useful for the method of the present invention uses a hydrogen fuel source 100 that comprises a hydrogen generation system that produces hydrogen from the hydrolysis of boron hydride compounds, a fuel cell 108, valves 110 and 114, a conduit 102 to deliver hydrogen from the hydrogen fuel source to the fuel cell, and a second conduit line 212 to connect an electrode compartment (for example, either the cathode or anode chamber) of the fuel cell and storage region 122 to the hydrogen fuel source 100. For a hydrogen generation system that produces hydrogen from the hydrolysis of boron hydride compounds, pressure fluctuations within the hydrogen generation system can arise from periodic actions in the reactor, such as reaction fronts controlled by either thermodynamic changes or reactant fluctuations, or may be induced using system controls. These fluctuations may be used to create the pressure cycles in the fuel cell power system, which are used to purge water from the fuel cell.

The hydrogen generation system present in hydrogen source 100 comprises a fuel reservoir 202, a reaction chamber 204, a product reservoir 208, and a gas-liquid separator 206; other components not shown may be present in hydrogen generation systems. Components are shown individually in FIG. 6 for illustrative purposes and one or more of these components may be combined in one apparatus for efficiency; for example, the functions of the product reservoir and gas-liquid separator may be combined in one component. Additional representative systems and processes for generating hydrogen from boron hydride fuel solutions are described in U.S. Pat. No. 6,534,033, entitled “A System for Hydrogen Generation,” which is hereby incorporated herein by reference in its entirety. Preferred fuels for such hydrogen generation systems are those boron hydrides that are water soluble, stable in aqueous solution and have the general formula M(BH₄)ₙ. A preferred fuel solution comprises from about 10% to about 35% by weight sodium borohydride and about 0.01 to about 5% by weight sodium hydroxide as a stabilizer. Additional representative systems and processes for generating hydrogen from solid boron hydride fuels are described in U.S. patent application Ser. No 11/105,549, “Systems and Methods for Hydrogen Generation from Solid Hydrides,” and U.S. patent application Ser. No. 11/524,446, “Compositions and Methods for Hydrogen Generation,” the disclosures of both of which are hereby incorporated herein by reference in their entirety.

In boron hydride-based hydrogen generation systems, a reaction occurs to produce hydrogen gas and product salt as in Equation 2, which is representative of a borohydride based hydrogen generation system where MBH₄ and MB(OH)₄, respectively, represent a metal borohydride and a metal borate and where M is a monovalent metal cation.

MBH₄+4H₂O→MB(OH)₄+4H₂+heat Equation 2

The borohydride fuel solution is metered from storage tank 202 and delivered into reaction chamber 204 containing a catalyst or other reagent to promote hydrolysis of the borohydride shown in Equation 2 to generate hydrogen and a borate salt. The reaction chamber preferably contains a reagent, such as a catalyst metal supported on a substrate. The preparation of such supported catalysts is taught, for example, in U.S. Pat. No. 6,534,033 entitled “System for Hydrogen Generation.” Other catalysts or reagents that promote the hydrolysis of borohydride compounds including, for example, unsupported metals, acids, or heat, can alternatively be present in the reaction chamber. The product stream is carried to the gas liquid separator 206 and the hydrogen gas may be processed to a desired temperature and humidity by passage through optional heat exchangers, condensers, and dryers before delivery to a fuel cell 108 via conduit line 102. The borate byproduct is transported to the product reservoir 208.

Initially, referring to FIG. 5, at T₀ all components in the system shown in FIG. 6 may reside at an initial pressure, P₀ (Start-Up Step). In the Pressurization Step, the rate and amount of hydrogen produced by the hydrogen generation system may be set by controlling the flow of the fuel solution into the reaction chamber. Initiating fuel flow and hydrogen production results in pressurization of the system to the operating pressure P₁ of the fuel cell 108.

In the Fuel Cell Operation Step, as the fuel cell consumes hydrogen to generate electricity, the pressure in the communicating regions falls to a lower pressure, P₂. Valves 110 and 114 are closed to isolate the region 122 from pressure swings in the fuel cell power system and maintain this area at P₂.

In the Re-Pressurization Step, additional hydrogen is generated by the hydrogen generation system and delivered from the hydrogen supply 100 to re-pressurize those system components in communication to a pressure higher than P₂, such as P₁; the isolated region 122 remains at the lower pressure P₂.

In the Fuel Cell Purge Step, the pressure in the hydrogen source 100 and the fuel cell at the higher pressure P₁ forces water from the fuel cell cathode through valve 110 into the reservoir 122. With valve 110 open and 114 closed, all communicating regions can equilibrate to the same pressure, P₃. Closing valve 110 and 114 would allow fuel cell 108 to re-pressurize to pressure P₂.

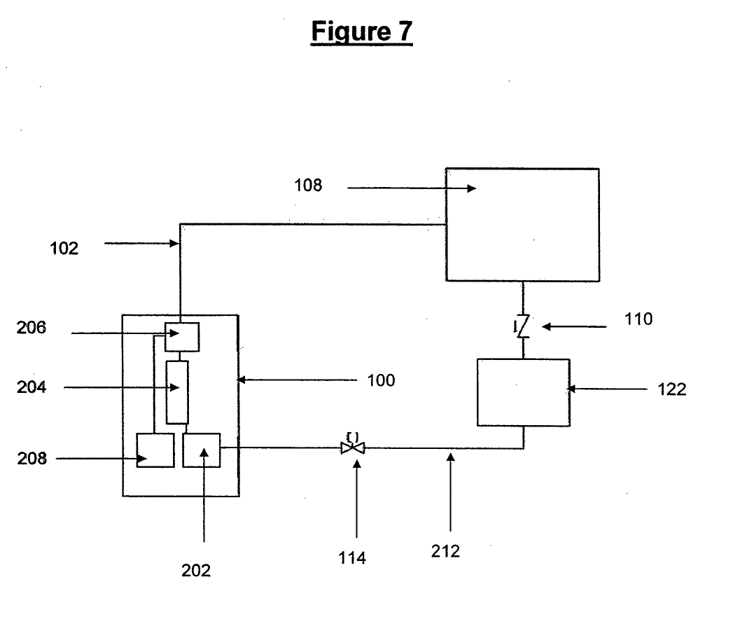

In a Reclamation Step, any accumulated materials present in the region 122 can be transferred to the gas/liquid separator 206 by opening the valve 114. The higher pressure in region 122 (e.g., P₃>P₂) forces any accumulated water and hydrogen into system 100 into the gas/liquid separator 206, which transfers the liquid water into the product reservoir 208 as shown in FIG. 6. In an alternative configuration as illustrated in FIG. 7, hydrogen and water may also be sent directly to fuel tank 202. After this event, the communicating regions may all equilibrate to the same pressure, P₂. Following the purge from region 122 to the hydrogen source 100, valves 114 and 110 are closed to again isolate region 122 and maintain it at pressure P₂, and the cycle of fuel cell operation, pressurization, and fuel cell purge can repeat by operating valves 110 and 114 and the hydrogen generation system.

When the reclaimed water and hydrogen is provided to storage tank 202, the hydrogen can be delivered to the fuel cell by passing through the reaction chamber 206 where it combines with hydrogen newly generated from the fuel solution, and the combined hydrogen stream delivered to the fuel cell via conduit line 102. The water recovered from the fuel cell allows a fuel concentrate to be stored and diluted to a desired concentration. It is typically desirable to use the highest possible fuel concentrations to maximize hydrogen storage density within the system. Where the concentration of the metal hydride in the fuel exceeds the maximum solubility of the particular salt utilized, the fuel will be in the form of a slurry or suspension. By adding water to the fuel storage reservoir, these higher concentration fuels can be diluted to the desired concentration for hydrogen generation.

While the present invention has been described with respect to particular disclosed embodiments, it should be understood that numerous other embodiments are within the scope of the present invention. The fuel cell system of the present invention may purge to the atmosphere in addition to operating in a closed loop system as presented in the illustrated embodiments. Periodic purges expel contaminants from the fuel cell and prevent their accumulation within the system. The closed loop systems may further comprise a toggle valve connected to an exit conduit such that the fuel cell power system can cycle between expelling materials such as water and gases that have accumulated in an electrode compartment such as the cathode or anode, and transporting these materials to region 120 and/or the hydrogen source 100. Alternatively, the recycle loop may be omitted and the fuel cell purge methods of the present invention may be used to remove the accumulated materials within an electrode compartment from the system without a reclamation loop. To comply with regulations regarding hydrogen release from fuel cells or to minimize the amount of hydrogen released in any individual purge cycle, hydrogen storage regions such as an accumulator or metal hydride can be incorporated into a fuel cell system purge cycle as taught herein. Materials expelled from the electrode compartment may be purged to an accumulator equipped with a needle valve which will release the contents from the system slowly.

The above description and drawings illustrate preferred embodiments which achieve the features and advantages of the present invention. It is not intended that the present invention be limited to the illustrated embodiments. Any modification of the present invention which comes within the spirit and scope of the following claims should be considered part of the present invention.

What is claimed as new and desired to be protected by Letters Patent of the United States is:

1. A power system, comprising:
a fuel cell;
a hydrogen source for providing hydrogen for use by the fuel cell;
a first storage region configured to store at least a portion of fluid material accumulated in an electrode chamber of the fuel cell; and
a control system configured to recycle at least part of the fluid material from the first storage region to the fuel cell or the hydrogen source.

2. The system of claim 1, wherein the fluid material comprises hydrogen.

3. The system of claim 1, wherein the fluid material comprises water.

4. The system of claim 1, wherein the fluid material comprises water and hydrogen.

5. The system of claim 1, wherein the first storage region comprises a storage tank.

6. The system of claim 1, wherein the first storage region is in communication with the anode compartment of the fuel cell.

7. The system of claim 1, wherein the first storage region is in communication with the cathode compartment of the fuel cell.

8. The system of claim 1, wherein the first storage region comprises at least a portion of a conduit in communication with the fuel cell and the hydrogen source.

9. The system of claim 1, wherein the control system comprises a plurality of valves, at least one of the valves being a first valve operable to prevent fluid communication between the fuel cell and the first storage region.

10. The system of claim 9, wherein another of the plurality of valves is a second valve operable to prevent fluid communication between the hydrogen source and the fuel cell.

11. The system of claim 1, further comprising a second storage region in fluid communication with the fuel cell and the hydrogen source, the second storage region being configured to store at least a portion of the fluid material from the first storage region.

12. The system of claim 11, further comprising a first valve operable to prevent fluid communication between the fuel cell and the first storage region, a second valve operable to prevent fluid communication between the first storage region and the second storage region, and a third valve operable to prevent fluid communication between the hydrogen source and the second storage region.

13. The system of claim 12, wherein a first isolable region comprises the fuel cell, the second storage region, the first valve and the third valve and a second isolable region comprises the first storage region, the first valve and the second valve.

14. The system of claim 13, wherein each of the first isolable region and the second isolable region is bounded by the first valve.

15. The system of claim 13, wherein the control system is adapted to cycle pressure within each of the first and second isolable regions between a first operating pressure and a second pressure, the second pressure being lower than the first operating pressure.

16. The system of claim 15, wherein the control system is adapted to purge at least part of the hydrogen from the fuel cell to the first storage region by activating the first valve when the first isolable region is at the first operating pressure and the second isolable region is at the second pressure.

17. The system of claim 13, wherein at least one of the first valve, the second valve and the third valve is selected from the group consisting of a check valve, a chemical valve, a mechanical valve and a gas pressure regulator.

18. The system of claim 1, wherein the hydrogen source is capable of forming hydrogen gas via reaction of a solid chemical hydride with an acidic reagent.

19. The system of claim 1, wherein the hydrogen source further comprises:
a fuel storage area configured to store a hydrogen generating fuel;
a reaction chamber; and
a hydrogen separation area.

20. The system of claim 19, wherein the hydrogen generating fuel is a reformable fuel.

21. The system of claim 1, further comprising a hydrogen outlet configured to deliver hydrogen gas to the fuel cell.

22. The system of claim 1, wherein the fuel cell is selected from the group consisting of a proton exchange membrane fuel cell, a solid oxide fuel cell, and an alkaline fuel cell.

23. A power system, comprising:
a fuel cell;
a hydrogen source for generating hydrogen for use by the fuel cell;
a storage region configured to store at least a portion of fluid material accumulated in an electrode chamber of the fuel cell;
a first valve operable to prevent fluid communication between the fuel cell and the storage region; and
a second valve operable to prevent fluid communication between the storage region and the hydrogen source.

24. The system of claim 23, wherein the storage region is in communication with the anode compartment of the fuel cell.

25. The system of claim 23, wherein the storage region is in communication with the cathode compartment of the fuel cell.

26. The system of claim 23, wherein the storage region is capable of being maintained at a first pressure when the first valve and the second valve are closed.

27. The system of claim 26, wherein the pressure of each of the fuel cell, hydrogen source and storage region is capable of being cycled between the first pressure and a second operating pressure, the second operating pressure being higher than the first pressure.

28. The system of claim 27, wherein at least part of fluid material in an electrode of the fuel cell is capable of being purged from the fuel cell to the storage region when the fuel cell is at the second operating pressure and the storage region is at the first pressure.

29. The system of claim 28, wherein at least part of the fluid material from the storage region is removed from the storage region to the hydrogen source when the storage region is at a third pressure and the hydrogen source is at the first pressure, the third pressure being higher than the first pressure.

30. An electrical power system for connection to a power consuming device, comprising:
a hydrogen gas generator;
a fuel cell;
a first storage chamber configured to store at least a portion of fluid material accumulated in an electrode chamber of the fuel cell;
a second storage chamber configured to store at least a portion of fluid material stored in the first storage chamber; and
at least one valve configured to maintain a pressure difference between the fuel cell and the first storage chamber and to subsequently purge at least a portion of fluid material accumulated at the electrode to the first storage chamber.

31. The system of claim 30, wherein the fluid material comprises hydrogen.

32. The system of claim 30, wherein the fluid material comprises water.

33. The system of claim 30, wherein the fluid material comprises water and hydrogen.

34. The system of claim 30, wherein the electrode is a cathode.

35. The system of claim 30, wherein the electrode is an anode.

36. The system of claim 30, further comprising a second valve configured to maintain a pressure difference between the first storage chamber and the second storage chamber and to subsequently remove at least a portion of fluid material from the first storage chamber to the second storage chamber.

37. The system of claim 30, wherein the system further comprises a closed loop configured to recycle at least part of the fluid material from the first storage chamber to the second storage chamber, and then to the fuel cell through the first and second valves.

38. The system of claim 30, further comprising a first valve operable to prevent fluid communication between the fuel cell and the first storage chamber, a second valve operable to prevent fluid communication between the first storage chamber and the second storage chamber, and a third valve operable to prevent fluid communication between the hydrogen source and the second storage chamber.

39. The system of claim 38, wherein the fuel cell, the second storage chamber, the first valve and the third valve are part of a first isolable region, and wherein the first storage chamber, the first valve and the second valve are part of a second isolable region.

40. The system of claim 39, wherein each of the first and second isolable regions is capable of being cycled between a first operating pressure and a second pressure, the second pressure being lower than the first operating pressure.

41. The system of claim 40, wherein the system is configured to purge at least part of the fluid material from the fuel cell to the first storage region when the first isolable region is at the first operating pressure and the second isolable region is at the second pressure.

42. The system of claim 41, wherein the system is capable of purging at least part of the fluid material from the first storage region to the second storage region when the first isolable region is at a pressure higher than the pressure of the second isolable region.

43. The system of claim 30 further comprising a water storage region configured to store at least part of the fluid material from the first storage chamber or the second storage chamber.

44. The system of claim 30, wherein the hydrogen generator is capable of generating hydrogen via heating a solid fuel comprising a chemical hydride.

45. The system of claim 30, wherein the hydrogen generator is capable of forming hydrogen gas via reaction of a solid chemical hydride with an acidic reagent.

46. The system of claim 30, wherein the at least one valve is a check valve, a chemical valve, a mechanical valve or a gas pressure regulator.

47. A method for purging a fuel cell of a power system for connection to a power consuming device, wherein the power system includes a hydrogen gas generator, a fuel cell, and a first storage region connected to the fuel cell, comprising:
activating the hydrogen generator to supply hydrogen gas to the fuel cell;
creating a pressure difference between the fuel cell and the first storage region; and
allowing at least a portion of fluid material accumulated in an electrode chamber of the fuel cell to purge to the first storage region in response to the pressure difference.

48. The method of claim 47, further comprising purging the portion of fluid material from the fuel cell by opening at least one valve between the fuel cell and the first storage region.

49. The method of claim 47, further comprising:
closing a first valve in communication with the fuel cell and the first storage region;
closing a second valve in communication with the fuel cell and the hydrogen gas generator to isolate the first storage region from pressure fluctuations in the system and to maintain the first storage chamber at a first pressure;
increasing the pressure of the fuel cell to a second pressure which is greater than the first pressure; and
subsequently opening the first valve to allow the at least a portion of fluid material from the fuel cell to purge to the first storage region.

50. The method of claim 49, further comprising conducting at least one cycle comprising system pressurization, fuel cell operation, and fuel cell purge by operating at least the first valve and the second valve in sequence.

51. The method of claim 47 further comprising reducing pressure in the power system by consuming hydrogen by the fuel cell to produce electricity.

52. A method for hydrogen generation, comprising:
providing a fuel cell in communication with a hydrogen generation system and with a first storage region;
conducting at least one chemical reaction in a reaction chamber of the hydrogen generation system to produce hydrogen gas; and
purging at least a portion of fluid material accumulated at the electrode of the fuel cell to the storage region in response to a pressure differential between the fuel cell and the first storage region.

53. The method of claim 52 further comprising storing the fluid material purged from the fuel cell in the first storage chamber.

54. The method of claim 52 further comprising:
providing a second chamber in communication with the hydrogen generation system and the fuel cell;
activating one or more of a first valve operable to prevent fluid communication between the fuel cell and the first storage chamber, a second valve operable to prevent fluid communication between the first storage chamber and the second chamber, and a third valve operable to prevent fluid communication between the hydrogen generation system and the second chamber to isolate the first storage region from an increase in pressure in the fuel cell;
increasing the pressure in the fuel cell; and
subsequently opening said valve to purge the at least a portion of fluid material accumulated at the electrode of the fuel cell to the first storage chamber.

55. The method of claim 54 further comprising activating a second of said valves to remove at least part of the fluid material from the first storage chamber to the second chamber.

56. The method of claim 55 wherein the fluid material comprises water, and at least part of the water from the second chamber is transferred to a water storage area.

57. The method of claim 56 further comprising diluting a fuel used in the hydrogen generation system with water from the water storage area.
